(19) United States
(12) Patent Application Publication
(10) Pub. No.: US 2021/0051028 A1
(43) Pub. Date: Feb. 18, 2021

(54) CERTIFICATE DISCOVERY AND WORKFLOW AUTOMATION

(71) Applicant: ServiceNow, Inc., Santa Clara, CA (US)

(72) Inventors: Tal Kapon, Givataim (IL); Sreenevas Subramaniam, Dublin, CA (US); Laxman Rao Tallury, Bengaluru (IN); Amit Dhuleshia, San Diego, CA (US); Durgaprasad Chikmagalur Prabhudeva, Bangalore (IN); Venkata Phani Kumar Gudladona, Bangalore (IN); Gregory James Grisco, San Diego, CA (US); Vishal Rao, Stoneham, MA (US); Thanh Trac Phan, San Diego, CA (US); Robert Jose Dunlap, Bonita, CA (US); Barkha Bhatia, Milpitas, CA (US); Jason Brian Ziccardi, San Diego, CA (US)

(21) Appl. No.: 16/538,621

(22) Filed: Aug. 12, 2019

(51) Int. Cl. H04L 9/32; H04L 29/06

(52) U.S. Cl. CPC H04L 9/3268; H04L 61/2007; H04L 63/0281

(57) ABSTRACT

An embodiment includes executing a discovery pattern for the certificate authority, where the discovery pattern contains instructions for obtaining one or more digital certificates from the certificate authority; obtaining, from the certificate authority, a representation of a digital certificate acquired by a managed network from the certificate authority; storing, in a first set of mappings, a first new mapping between the certificate authority and the digital certificate; receiving, from a computing device disposed with the managed network, an indication that the digital certificate is installed on the computing device;, storing, in a second set of mappings, a second new mapping between the digital certificate and the computing device; determining that the digital certificate is expired; and storing, in a third set of mappings, a third new mapping between the digital certificate and a critical status indicator.

### BACKGROUND

Digital certificates are electronic documents that demonstrate ownership over a public key. When combined with a corresponding private key, the public key/private key pair may be used to establish secure communication channels between a computing device and other computing devices or networks. For example, transport layer security (TLS), secure sockets layer (SSL), secure shell (SSH), and virtual private networks (VPNs) may all be enabled by public key/private key pairs.

Generally speaking, a digital certificate contains the public key and a reference to a certificate authority that can validate the authenticity of the digital certificate. Using the certificate authority (e.g., communicating therewith), client devices attempting to access resources from the computing device or network to which the public key pertains can confirm the authenticity of the digital certificate and then proceed to use the public key to establish a secure communication channel with the computing device or network. Other uses of digital certificates are also possible.

Sometimes, a digital certificate has an expiration date after which the digital certificate is no longer valid. When a client device determines that a digital certificate has expired, the client device may refrain from accessing resources protected by the digital certificate. Alternatively, the client device may attempt to access these resources, but with the understanding that they may not be legitimate (e.g., a malicious entity may be pretending to be the computing device or network). Either case represents a security risk that should be avoided.

### SUMMARY

As digital certificates play an important role in establishing secure communication channels, expired certificates may pose significant difficulties for the proper operation of an enterprise, for example. Nonetheless, identifying and renewing expired digital certificates can be difficult. An enterprise may have tens or hundreds of digital certificates installed across various computing devices, making management of these digital certificates unduly complex. Moreover, digital certificates can be acquired from various certificate authorities, making renewing these digital certificates challenging as well, because each digital certificate would need to be renewed via the proper certificate authority.

The present disclosure provides improvements to a remote network management platform that can address these and other issues. In particular, a remote network management platform may provide certificate discovery services to an enterprise's managed network. During operation, the certificate discovery services may identify digital certificates on the managed network, determine expiring or expired digital certificates, and renew the expiring or expired digital certificates on behalf on the enterprise.

In addition to enabling automated or semi-automated identification and renewal of expired or soon-to-expire digital certificates, the embodiments described herein provide numerous other advantages. For instance, these embodiments can be utilized to identify “idle” certificates—digital certificates that were acquired, but are not installed on the managed network. The enterprise may then decide to deploy or decommission these idle certificates.

Accordingly, a first example embodiment may involve a computational instance including persistent storage. The computational instance may be dedicated to a managed network. The first example embodiment may also involve one or more processors. The one or more processors may be configured to remotely access a certificate authority using access credentials thereof and, while remotely accessing the certificate authority, execute a discovery pattern for the certificate authority, where the discovery pattern contains instructions for obtaining one or more digital certificates from the certificate authority. As a result of execution of the discovery pattern, the one or more processors may obtain, from the certificate authority, a representation of a digital certificate acquired by the managed network from the certificate authority. The one or more processors may be further configured to store, into a first set of mappings in the persistent storage, a first new mapping between the certificate authority and the digital certificate. The one or more processors may be further configured to receive, from a computing device disposed with the managed network, an indication that the digital certificate is installed on the computing device and, in response to receiving the indication, store, in a second set of mappings in the persistent storage, a second new mapping between the digital certificate and the computing device. The one or more processors may be further configured to determine that the digital certificate is expired or within a threshold amount of time from expiration and, in response to determining that the digital certificate is expired or within the threshold amount of time from expiration, store, in a third set of mappings in the persistent storage, a third new mapping between the digital certificate and a critical status indicator.

In a second example embodiment, an article of manufacture may include a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 provides network architecture for discovery and administration of digital certificates, in accordance with example embodiments.

FIG. 7 depicts example discovery mechanisms, in accordance with example embodiments.

FIG. 8A depicts a certificate model, in accordance with example embodiments.

FIG. 8B depicts an application dependency diagram, in accordance with example embodiments.

FIG. 9 depicts a message flow, in accordance with example embodiments.

FIG. 10 depicts a message flow, in accordance with example embodiments.

FIGS. 11A-11C depict web pages, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. Example Computing Devices and Cloud-Based Computing Environments

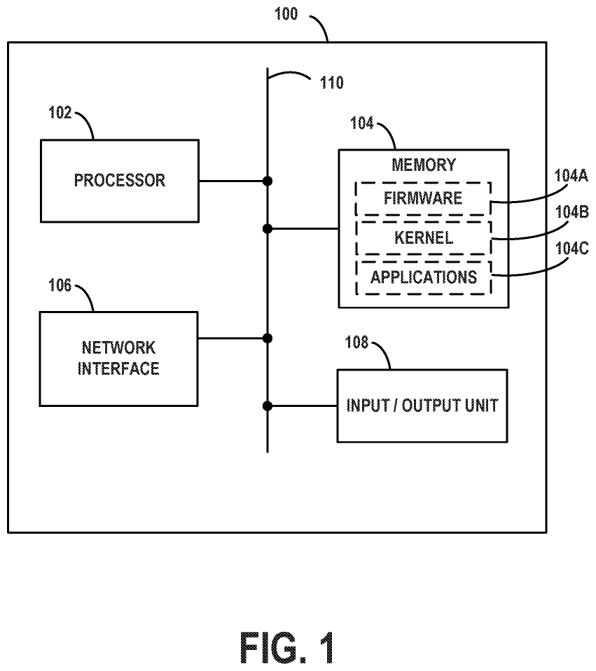

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

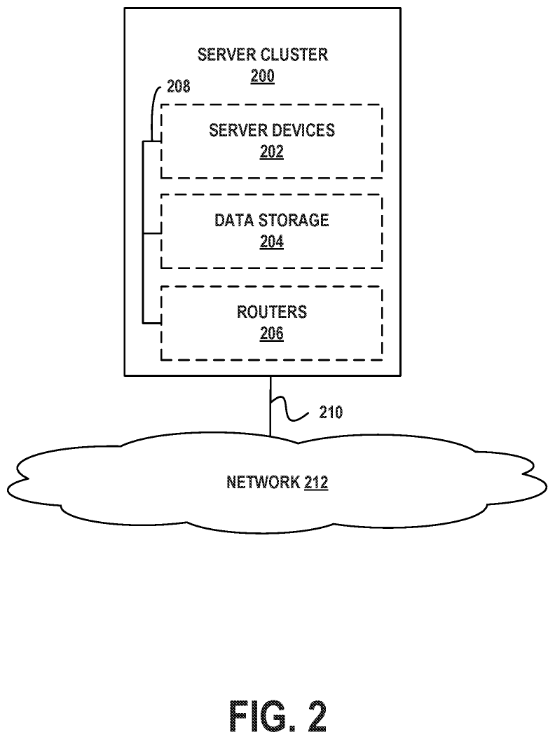

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages.

### III. Example Remote Network Management Architecture

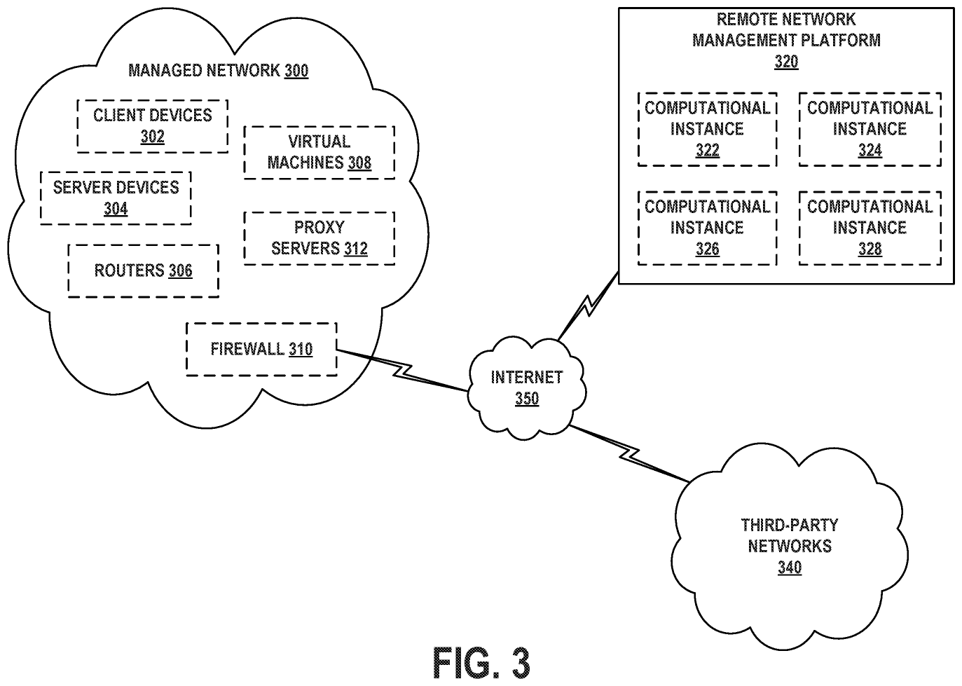

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent one or more server devices and/or one or more databases that provide a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows with one or more database tables).

For purpose of clarity, the disclosure herein refers to the physical hardware, software, and arrangement thereof as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of physical or virtual servers and database devices. Such a central instance may serve as a repository for data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® AZURE®. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

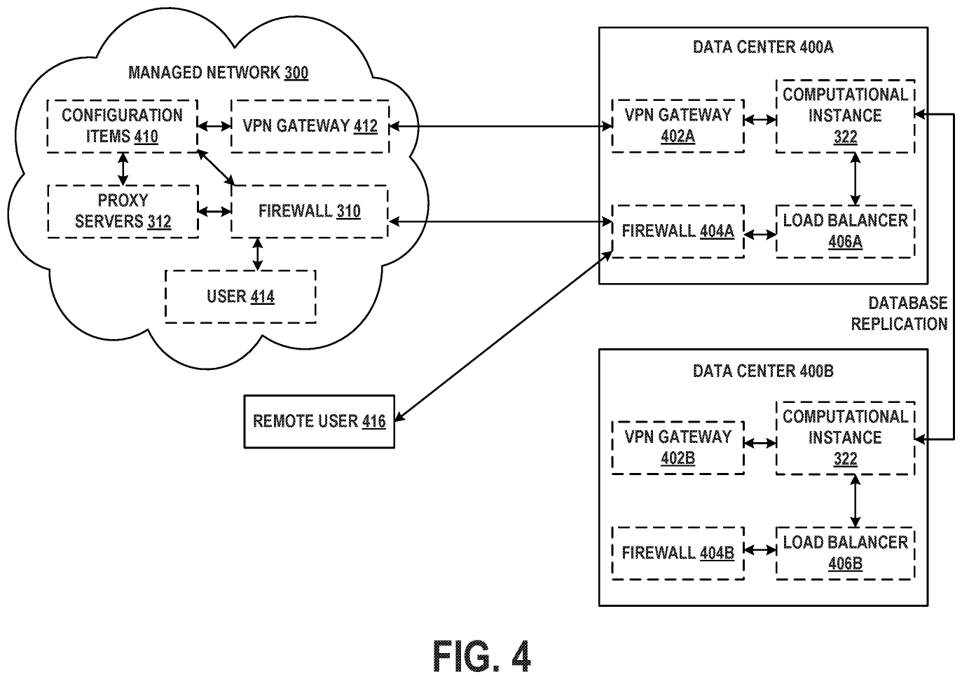

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

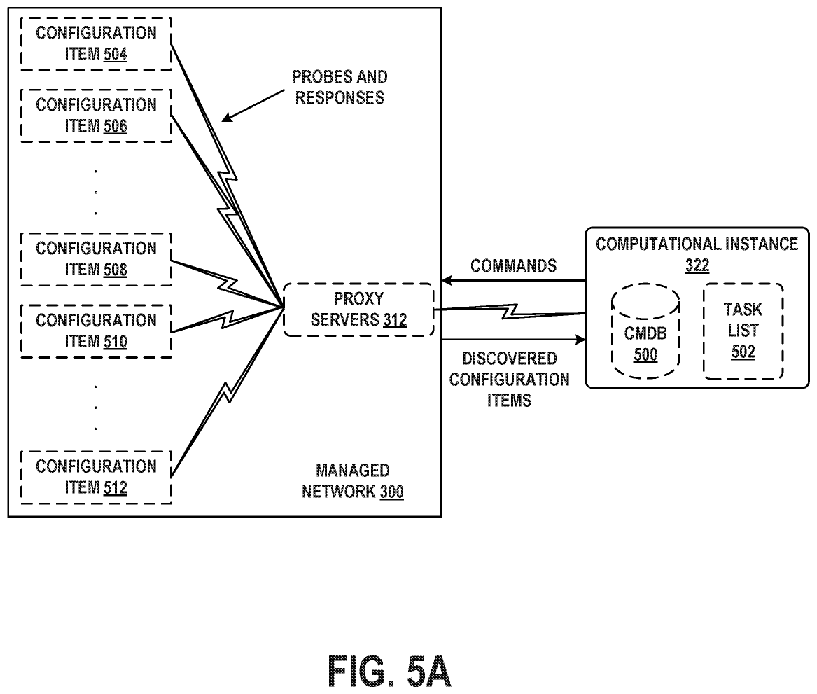

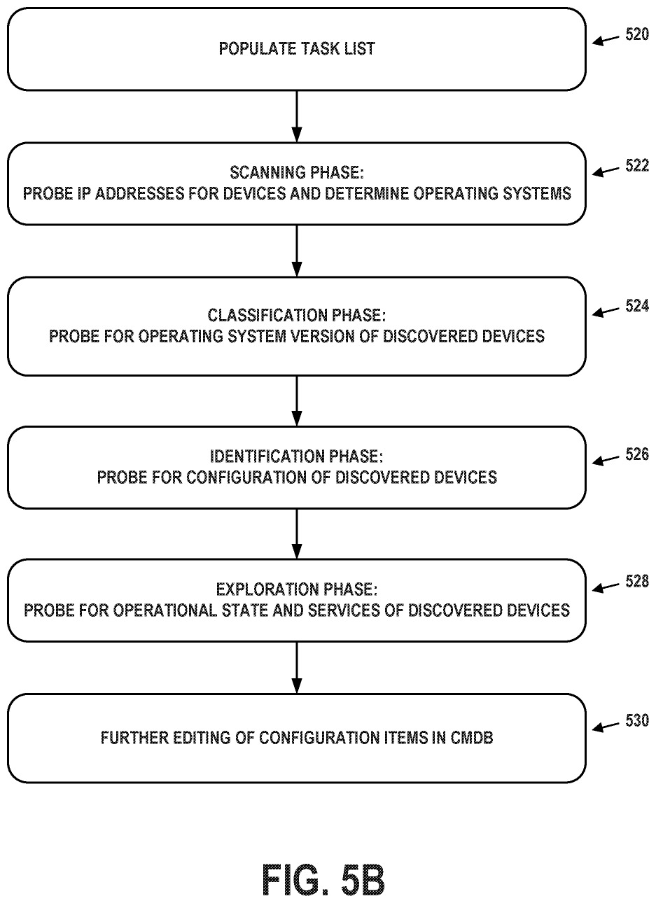

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. Example Digital Certificate Management

Management of digital certificates can be a complex task, especially for enterprises with numerous certificates acquired from several certificate authorities. Also referred to as “digital certificate sprawl,” this lack of certificate administration may be overwhelming and can inhibit entities from accessing computing resources and services from the enterprise.

Alleviating the digital certificate sprawl can be onerous and unduly time consuming. Proper certificate administration not only entails a meticulous tracking system, but also can involve determining whether acquired digital certificates are actually installed, how many instances of the digital certificates are installed, where those instances are located, and so on. Rather than deal with this complexity, many enterprises ignore the problem, letting the certificate sprawl become widespread and problematic.

The embodiments described herein present a technical improvement to a remote network management platform that can address this and other issues. In particular, the remote network management platform may support certificate discovery services that can identify, manage, and renew digital certificates on behalf on an enterprise. Advantageously, by using the embodiments herein, the enterprise need not concern itself with the complexities of digital certificates or interfacing with certificate authorities, saving significant time and resources. Other advantages and improvements are also possible and will be understood from the discussion herein.

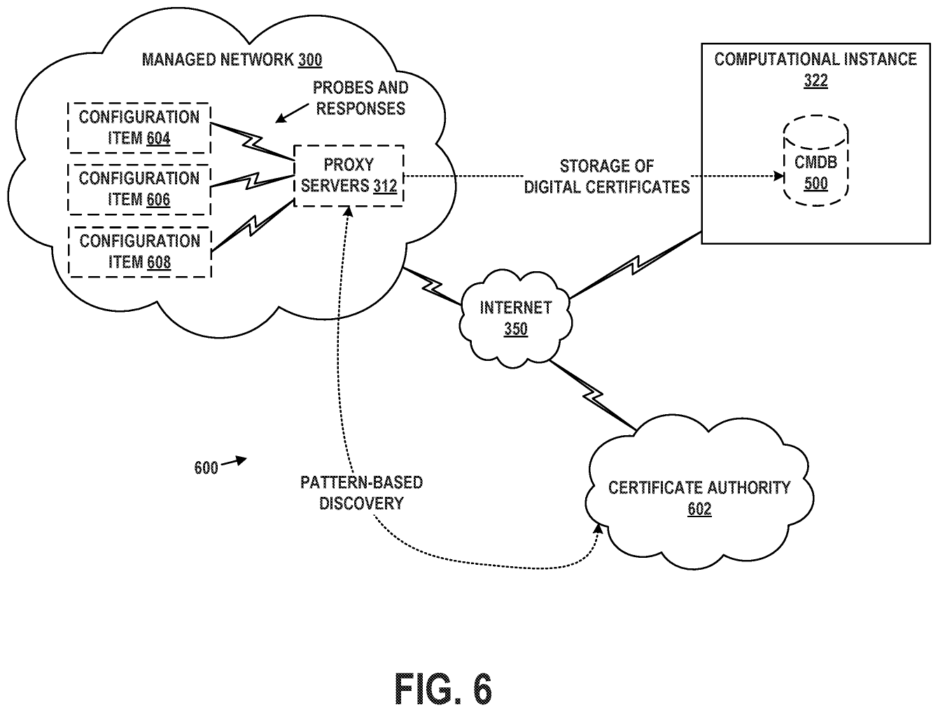

FIG. 6 provides network architecture 600 for discovery and administration of digital certificates, in accordance with example embodiments. Network architecture 600 includes managed network 300, computational instance 322, and certificate authority 602, all connected by way of Internet 350.

Managed network 300 includes proxy server(s) 312, configuration item 604, configuration item 606, and configuration item 608. In line with the discussion above, configuration items 604, 606, and 608 may represent physical or virtual devices, applications or services remotely discoverable or managed by computational instance 322. Configuration items 604, 606, and 608 may each be associated with a digital certificate used for identity verification and secure communications. For example, configuration items 604, 606, and 608 may take the form of web servers and the digital certificates may enable configuration items 604, 606, and 608 to engage in hypertext transfer protocol secure (HTTPS) communication with client devices. Thus, it may be of interest for managed network 300 to appropriately manage the digital certificates associated with configuration items 604, 606, and 608, or risk security and operational issues. Managed network 300 may also include other devices and software applications as described above, but these are omitted from FIG. 6 for purposes of simplicity.

Network architecture 600 also contains computational instance 322, which includes CMDB 500. As described above, computational instance 322 may be part of remote network management platform 320 and may include various devices and software services used to remotely administer aspects of managed network 300.

Certificate authority 602 may include a number of computational resources, such as processors, databases, APIs, authentication services, that operate to provide digital certificate services for managed network 300 and other networks. Namely, certificate authority 602 acts as a “trusted-third party” by verifying the identity of managed network 300 and issuing signed digital certificates to managed network 300. Examples of certificate authorities that may be embodied by certificate authority 602 include VERISIGN®, DIGICERT®, and COMODO®. Managed network 300 may have one or more sets of credentials (e.g., userids and passwords) with which it can securely access certificate authority 602. Through use of these credentials to log on to or otherwise access certificate authority 602, managed network 300 may acquire new digital certificates, view acquired digital certificates, delete unused certificates, renew expired digital certificates, and so on.

Certificate authority 602 may provide an application programming interface (API) for acquiring, querying, renewing digital certificates. This API may be a representational state transfer (REST) API using HTTP, for instance, but other types of APIs may be used. As an example, to retrieve an issued digital certificate from DIGICERT®, the request URL may take the following form: “https://api.digicert.com/order/{order_id}/certificate”, where {order_id} is an order number for a digital certificate acquired by managed network 300, such as “222307” The DIGICERT® example above is for purposes of illustration and not limiting. Other certificate authorities may use different query formats and APIs.

As shown by the dotted lines in FIG. 6, proxy server(s) 312 may execute pattern-based discovery on certificate authority 602. Generally speaking, a pattern is a series of operations that instruct a software application to carry out discovery operations. Patterns specify what credentials to use to access the certificate authority, what digital certificates therein to discover, and what CMDB tables to populate with these discovered digital certificates. Once the digital certificates are discovered, they may be stored in CMDB 500. Thus, proxy server(s) 312 may transmit the digital certificates to computational instance 322 for storage.

In addition to executing pattern-based discovery on certificate authority 602, proxy server(s) 312 may execute probe-based discovery on managed network 300. For example, proxy server(s) 312 may transmit probes to various devices, applications, and services in managed network 300, as previously described with respect to FIG. 5A.

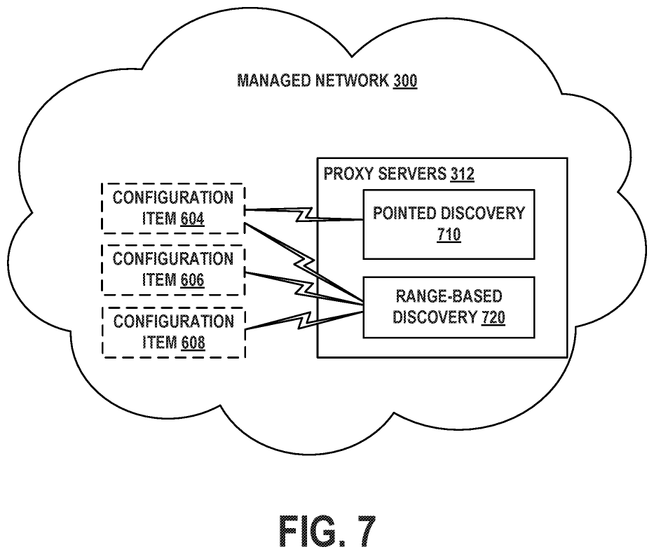

FIG. 7 depicts example mechanisms by which proxy server(s) 312 may execute probe-based discovery to discover digital certificates on managed network 300, in accordance with example embodiments. Generally, proxy server(s) 312 uses pointed discovery 710 and/or range based discovery 720, although other discovery mechanisms are also possible.

With pointed discovery 710, proxy server(s) 312 may transmit a probe to a particular IP address/port number (e.g., IP address 192.168.0.1, port 443) on managed network 300. Specification of the IP address/port may be accomplished by way of a web page or series of web pages hosted by computational instance 322 and provided to a user from managed network 300 upon request. Through the web pages, the user may enter an IP address/port number or perhaps a domain name, which proxy server(s) 312 can resolve to an IP address/port number via DNS servers. As an illustrative example, FIG. 7 shows that pointed discovery 710 operates to discover digital certificates associated with configuration item 604, while ignoring configuration item 606 and configuration item 608. In some examples, if no port number is specified by the user, pointed discovery 710 may default to port 443 (e.g., for HTTPS connections). Once the presence of a digital certificate at the particular IP address/port number has been discovered, the digital certificate is saved in CMDB 500.

As an example of how pointed discovery 710 can be performed, a command for discovering digital certificates is presented below. This command may be entered by way of a command line interface (e.g., a command shell or terminal) invoked on proxy server(s) 312, for example. The command utilizes the OPENS SL® library, however other libraries and commands are also possible. The command may roughly adhere to the following structure:

$ openssl s_client -showcerts -connect myhost.com:443

This particular command requests all digital certificates from port 443 of the host “myhost.com” (alternatively an IP address can be used rather than a hostname). A corresponding response to the command may be formatted as shown below:

--- BEGIN CERTIFICATE ---
MIIEzTCCA7WgAwIBAgISESHAjlbjcoBHxBYXS12oY6VjMA0GCSqGSIb3DQEBCwUA
...
CzgXBhDR3themzPx4jwx2ckNFpNDK/ 6yQgrKaHTewAAj
-----END CERTIFICATE-----
---
Server certificate
subject=/C=BE/OU=Domain Control Validated/CN=myhost.com
issuer=/C=BE/O=DigiCert nv-sa/CN=AlphaSSL CA - SHA256 - G2
---

This response has a first section containing a digital certificate and a second section contains details about the digital certificate, including the name of the issuing certificate authority (DIGICERT® in this case). Similar commands and responses that contain information regarding intermediate certificate authorities, encoded digital certificates, information on the ciphers used to negotiate with remote server, and so on may exist.

With range-based discovery 720, proxy server(s) 312 may transmit probes to a range of IP addresses for devices within managed network 300. In line with the discussion above, devices in managed network 300 may be assigned public IP addresses or private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). During range-based discovery 720, proxy server(s) 312 may be given a range of public or private IP addresses (e.g., the IP address range 192.168.0/24) and may initiate discovery of devices at each of these addresses by probing for open TCP and/or UDP ports to identify digital certificates. As an illustrative example, FIG. 7 shows that range-based discovery 720 operates to discover digital certificates associated with configuration item 604, configuration item 606, and configuration item 608. Once the presence of a digital certificate on a device at a particular IP address and its open ports has been discovered, the digital certificate is saved in CMDB 500. As with to pointed discovery 710, range-based discovery 720 may make use of the commands illustrated above (e.g., executing a OPENS SL® command on proxy server(s) 312) to obtain information on the digital certificates.

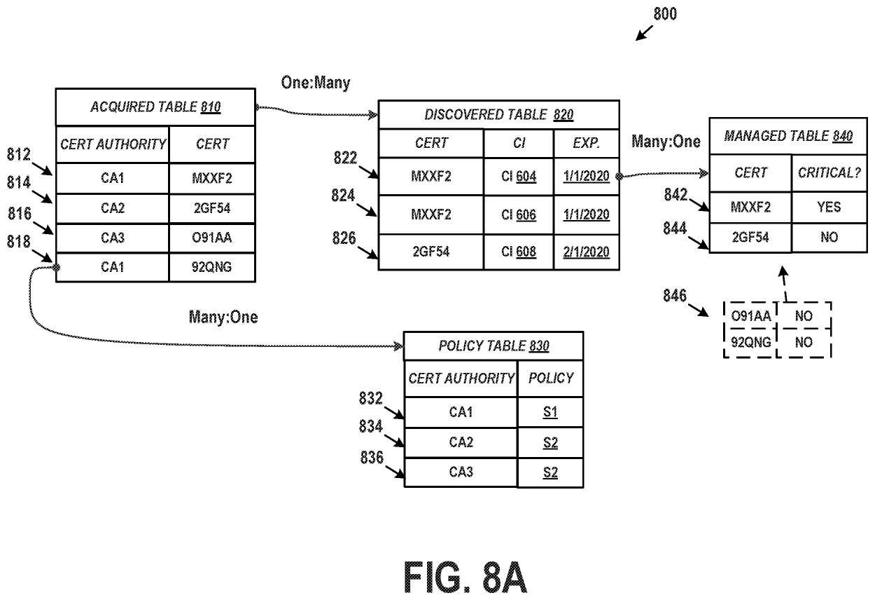

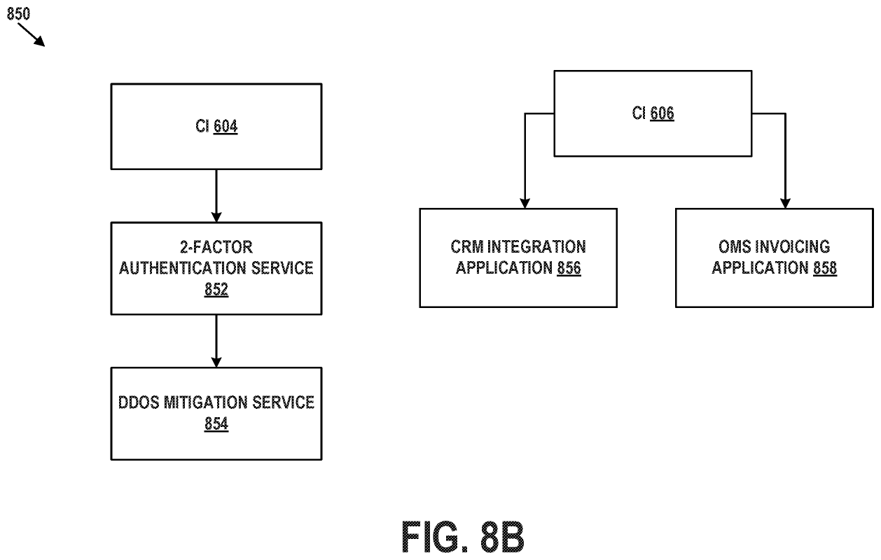

FIG. 8A depicts certificate model 800, in accordance with example embodiments. Certificate model 800 may include four tables: acquired table 810, discovered table 820, managed table 830, and policy table 840. Together these tables capture relationships between certificate authorities, digital certificates, and configuration items on managed network 300. Certificate model 800 may take the form of a series of tables on computational instance 322, perhaps in CMDB 500 or another database. In some examples, certificate model 800 can have more, fewer, and/or different types of tables than indicated in FIG. 8A. Moreover, acquired table 810, discovered table 820, managed table 830, and policy table 840 may be abridged for the purposes of clarity. But in practice, these tables may contain more, fewer, and/or different entries.

Acquired table 810 can include entries that map certificate authorities to digital certificates acquired by managed network 300. For example, entry 812 establishes that managed network acquired digital certificate MXXF2 from certificate authority 1 (CA1), entry 814 establishes that managed network acquired digital certificate 2GF54 from certificate authority 2 (CA2), entry 816 establishes that managed network 300 acquired digital certificate O91AA from certificate authority 3 (CA3), and entry 818 establishes that managed network 300 acquired digital certificate 92QNG from CA1. In some examples, an administrator from managed network 300 may input, for example through a web page or series of web pages provided by computational instance 322, the information to populate acquired table 810. In other examples, the entries in acquired table 810 may be populated via proxy server(s) 312 executing pattern-based discovery on certificate authority 602.

Discovered table 820 can include entries that map acquired digital certificates to configuration items on managed network 300. Additionally, each entry in discovered table 820 includes an expiration date. For example, entry 822 establishes that digital certificate MXXF2 is installed on configuration item 604 and has an expiration date of Jan. 1, 2020, entry 824 establishes that digital certificate MXXF2 is also installed on configuration item 606 and also has an expiration date of Jan. 1, 2020, and entry 826 establishes that digital certificate 2GF54 is installed on configuration item 608 and has an expiration date of Feb. 1, 2020. Similar to acquired table 810, an administrator from managed network 300 may input, for example through a web page or series of web pages provided by computational instance 322, the information to populate discovered table 820. Additionally and/or alternatively, entries in discovered table 820 may be populated via proxy server(s) 312 executing pointed discovery 710 and/or range-based discovery 720 on managed network 300. Discovered table 820 may have a many to one relationship with acquired table 810. In other words, digital certificates in acquired table 810 may have multiple corresponding entries in discovered table 820. By arranging digital-certificate-related information in multiple tables as shown, the overall amount of storage required for the information stored therein is reduced in comparison to attempting to store the information in a single table (e.g., many redundancies are eliminated).

In some embodiments, comparing the entries in discovered table 820 and acquired table 810 can provide information regarding “idle” certificates, or certificates that were acquired, but never installed on managed network 300. For example, entry 816 and entry 818 may be deemed idle, because both entries appear in acquired table 810, but not in discovered table 820. In examples, computational instance 322 and/or managed network 300 may choose to decommission idle certificates or install idle certificates onto configuration items.

Policy table 830 can include entries that map certificate authorities to policies. For example, entry 832 establishes that CA1 has an S1 policy, entry 834 establishes that the CA2 has an S2 policy, and entry 836 establishes that CA3 also has an S2 policy. As referred to herein, a policy is a programmatic script that defines actions to be carried out after specific conditions are met. For instance, a policy may stipulate that a digital certificate should be renewed if its expiration date is 1 month away, whereas another policy may stipulate that a digital certificate should be reviewed if its expiration date is 1 week away and the digital certificate is installed on more than 5 configuration items. Other policies also exist. Similar to acquired table 810 and discovered table 820, an administrator from managed network 300 may input, for example through a web page or series of web pages provided by computational instance 322, the information to populate policy table 830. Policy table 830 may have a one-to-many relationship with acquired table 810. In other words, certificate authorities in acquired table 810 may have one corresponding entry in policy table 830.

Managed table 840 includes unique entries that map digital certificates to critical statuses. A critical status indicates whether a digital certificate should be attended to (e.g., renewed or decommissioned). For example, entry 842 establishes that digital certificate MXXF2 should be attended to, while entry 844 establishes that digital certificate 2GF54 does not have to be attended to. The critical status of digital certificates can be based, for example, on policies set in place by policy table 830, the expiration date in discovered table 820, or other standards. Managed table 840 may have a many to one relationship with discovered table 820. In other words, digital certificates in discovered table 820, and may have one corresponding entry in managed network 840.

In some embodiments, managed table 840 may be “user facing”. That is, entries in managed table 840 may be presented to a user, perhaps via a GUI, hiding the intricate relationships in certificate model 800.

In some embodiments, managed table 840 may include entries from acquired table 810. For example, entry 816 and entry 818 of acquired table 810 may be part of managed table 840, as illustrated by the dashed lines 846. Entries in managed table 840 would still remain unique, but would now include entries for “idle” certificates (i.e., digital certificates that were acquired but never installed). In such a way, managed table 840 can similarly be used to identify critical statuses for idle certificates.

FIG. 8B depicts application dependency diagram 850, according to example embodiments. Application dependency diagram 850 is used herein to conceptually illustrate relationships between applications and configuration items on managed network 300. Application dependency diagram 850 includes configuration item 604, configuration item 606, 2-factor authentication service 852, distributed denial of service (DDOS) mitigation service 854, customer relationship management (CRM) integration application 856, and order management system (OMS) invoicing application 858.

Generally speaking, applications running on managed network 300 have one or more dependencies (represented on application dependency diagram 850 as directed arrows). Dependencies indicate how certain applications depend on other applications or configuration items during operation. For example, DDOS mitigation service 854 depends on 2-factor authentication service 852 during operation. In turn, 2-factor authentication service 852 depends on configuration item 604 (e.g., two-factor authentication service 852 may operate on configuration item 604). As another example, CRM integration application 856 and OMS invoicing application 858 both depend on configuration item 606 (e.g., CRM integration application 856 and OMS invoicing application 858 may both operate on configuration item 606).

When a digital certificate becomes critical, computational instance 322 may traverse application dependency diagram 850 to identify a chain of applications that may be affected by the critical digital certificate. For example, if a digital certificate associated with configuration item 606 becomes critical, computational instance 322 could traverse application dependency diagram 850 and recognize that CRM integration application 856 and OMS invoicing application 858 both have a dependency on configuration item 606. As a result, computational instance 322 may notify CRM integration application 856 and OMS invoicing application 858 that their operations may be affected or notify the appropriate people.

In examples, application dependency diagrams, such as application dependency diagram 850 can be prepared by users of managed network 300 and may be stored in as a table in CMDB 500 or as one or more tables, for example, in an another database on computational instance 322.

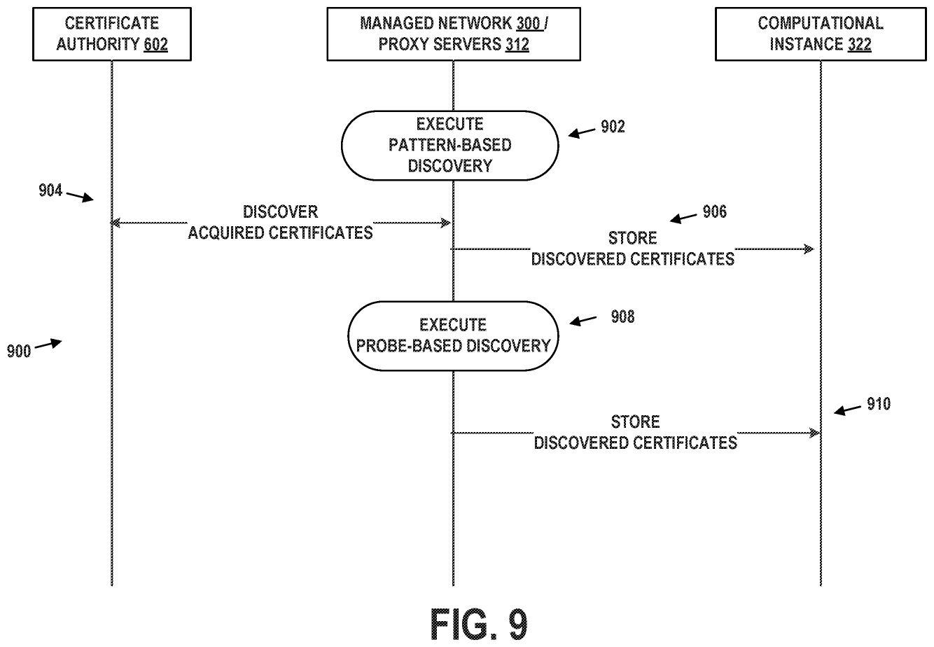

FIG. 9 depicts message flow 900, in accordance with example embodiments. Message flow 900 involves proxy server(s) 312 executing different modes of discovery, each mode focused on a particular source (e.g., digital certificates acquired from certificate authority 602, digital certificates installed on managed network 300). By way of example, message flow 900 may utilize computational instance 322, managed network 300/proxy server 312, and certificate authority 602 during operation. However, additional components, steps, or blocks, may be added to message flow 900.

At step 902, proxy server(s) 312 execute pattern-based discovery. As indicated by step 904, pattern-based discovery may be configured to discover digital certificates acquired by managed network 300 from certificate authority 602. A pattern may query one or more REST APIs of certificate authority 602, specifying authentication credentials and other parameters to determine the digital certificates. In response, certificate authority 602 may provide representations of the digital certificates specified by the query. Notably, since certificate authority 602 may represent one out of many certificate authorities used by manage network 300, the process of steps 902 and 904 may repeat for any number of different certificate authorities.

At step 906, proxy server(s) 312 transmits a request for computational instance 322 to store the discovered digital certificates, perhaps by storing them in acquired table 810.

At step 908, proxy server(s) 312 executes probe-based discovery. Probe-based discovery may be configured to discover digital certificates installed on configuration items within managed network 300. In examples, probe-based discovery may include pointed discovery 710 and/or range-based discovery 720. In response to the probes, configuration items within managed network 30 may provide representations of installed digital certificates.

At step 910, proxy server(s) 312 transmits a request for computational instance 322 to store the discovered digital certificates, e.g., in discovered table 820. In some embodiments, step 910 also involves computational instance 322 populating entries in managed table 840 by comparing entries in acquired table 810 to those in discovered table 820.

Notably, steps 904 and 906 may occur in parallel with steps 908 and 910. In other words, pattern-based discovery may occur in parallel (or perhaps before/after) with probe-based discovery.

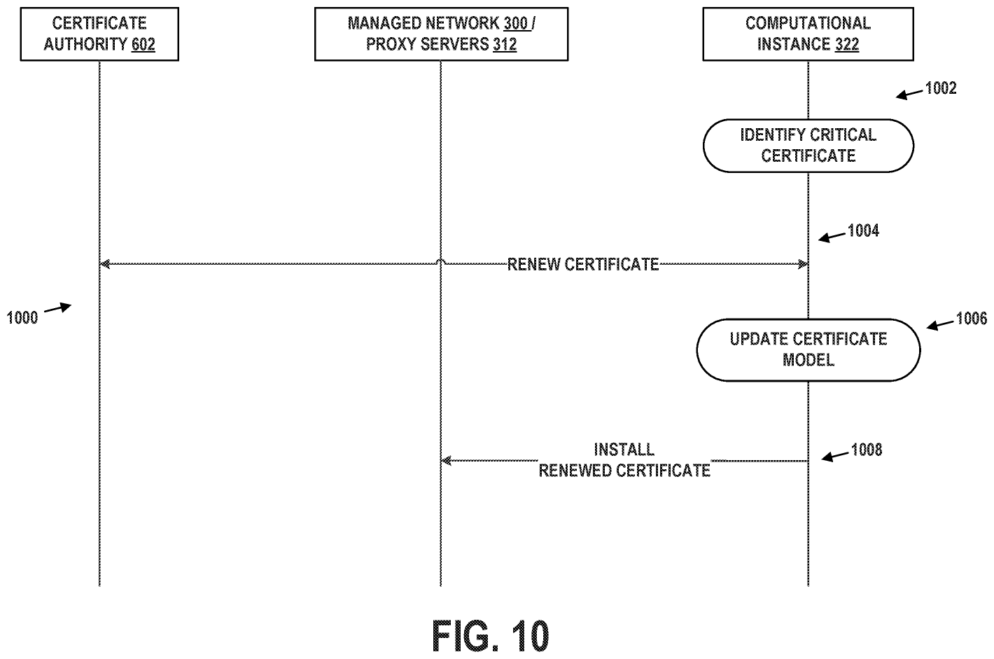

FIG. 10 depicts message flow 1000, in accordance with example embodiments. Message flow 1000 involves computational instance 322 identifying a critical digital certificate and appropriately performing actions to renew the critical digital certificate. By way of example, message flow 1000 may utilize computational instance 322, managed network 300/proxy server 312, and certificate authority 602 during operation. However, additional components, steps, or blocks, may be added to message flow 1000.

At step 1002, computational instance 322 interacts with CMDB 500 to determine that a digital certificate is critical and requires attention. In some embodiments, identifying the critical digital certificate involves determining whether the expiration date of any digital certificate in managed table 840 is within a threshold value (e.g., the expiration is within 1 day, 1 week, or 2 weeks). In some embodiments, identifying the critical digital certificate is based on policies listed in policy table 830.

At step 1004, computational instance 322 may execute instructions to renew the critical digital certificate from certificate authority 602. In some embodiments, the instructions may take on some or all of the properties of pattern-based discovery for certificate authority 602. For example, the instructions may use the authentication credentials for pattern-based discovery on certificate authority 602. The instructions may query one or more REST APIs of certificate authority 602, specifying authentication credentials and other parameters to renew the critical digital certificate. In response to the query, certificate authority 602 may provide computational instance 322 with a representation of a renewed digital certificate. Notably, since multiple digital certificates may be deemed critical, the process of step 1004 may repeat multiple times for each critical digital certificate.

In some embodiments, step 1004 may alternatively involve a client device requesting and receiving a representation of a user interface from computational instance 322. The representation may have thereon information regarding the critical digital certificate and may offer selectable options to renew the critical digital certificate. Upon a user selecting the option to renew the critical digital certificate, computational instance 322 may receive the request and proceed to renew the critical digital certificate from certificate authority 602.

In some embodiments, step 1004 may alternatively involve computational instance 322 transmitting a notification (e.g., in the form of an email, SMS message, etc.) to managed network 300 or appropriate people. The notification may have therein information regarding the critical digital certificate and may offer interactive options to renew the critical digital certificate (e.g., by responding to the email, responding to an SMS message, etc.). Upon a user interacting with the option to renew the critical digital certificate, computational instance 322 may receive the request and proceed to renew the critical digital certificate from certificate authority 602.

In some embodiments, step 1004 may involve computational instance 322 traversing an application dependency diagram, such as application dependency diagram 850. For instance, upon identifying a critical digital certificate, computational instance 322 may traverse an application dependency diagram to determine any application that directly or indirectly depends on a configuration item with the critical digital certificate installed thereon. Accordingly, each dependent application may be notified.

At step 1006, computational instance 322 stores the renewed digital certificate into CMDB 500. The act of storing may include, for example, updating entries in acquired table 810, deployed table 820, and managed table 840 to reflect the renewed digital certificate.

At step 1008, computational instance 322 installs the renewed digital certificate onto each computing device on managed network 300 that has the critical digital certificate installed thereon. Identifying the computing devices with critical digital certificates may be facilitated, for example, via entries in deployed table 820. Installation may involve, for example, updating task list 502 with commands for proxy server(s) 312 to place the renewed digital certificate into the root file system of the identified computing devices.

An advantage of message flow 1000 is that managed network 300 need not concern itself with identifying critical certificates but rather leaves this responsibility to computational instance 322. Further, through structure of certificate model 800, computational instance 322 can easily identify and install the renewed digital certificate onto tens, if not hundreds of computing devices and/or virtual machines operating on managed network 300. Other advantages are also possible.

### VI. Example Web Pages for Managing Digital Certificates

In some examples, remote network management platform 320 provides information about discovered digital certificates to users from managed network 300. This may be accomplished by way of a web page or series of web pages hosted by computational instance 322 and provided to the user from managed network 300 upon request. The layout and compilation of information in these web pages may enable efficient review of pertinent information about digital certificates within managed network 300. Additionally, the web pages may organize and arrange the information for digital certificates using graphics with intuitive visuals and easy to understand metrics.

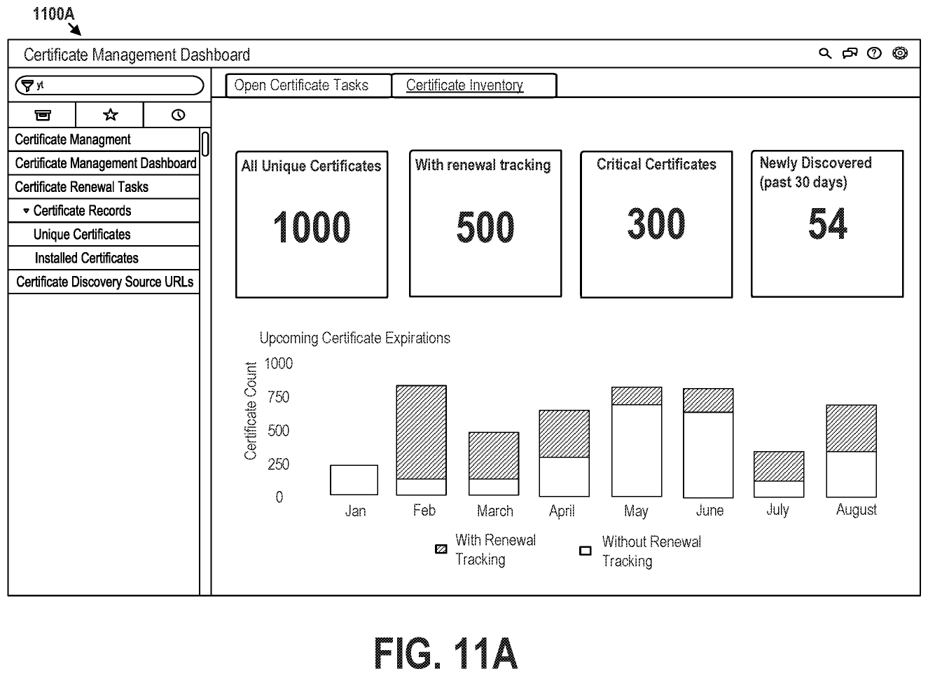

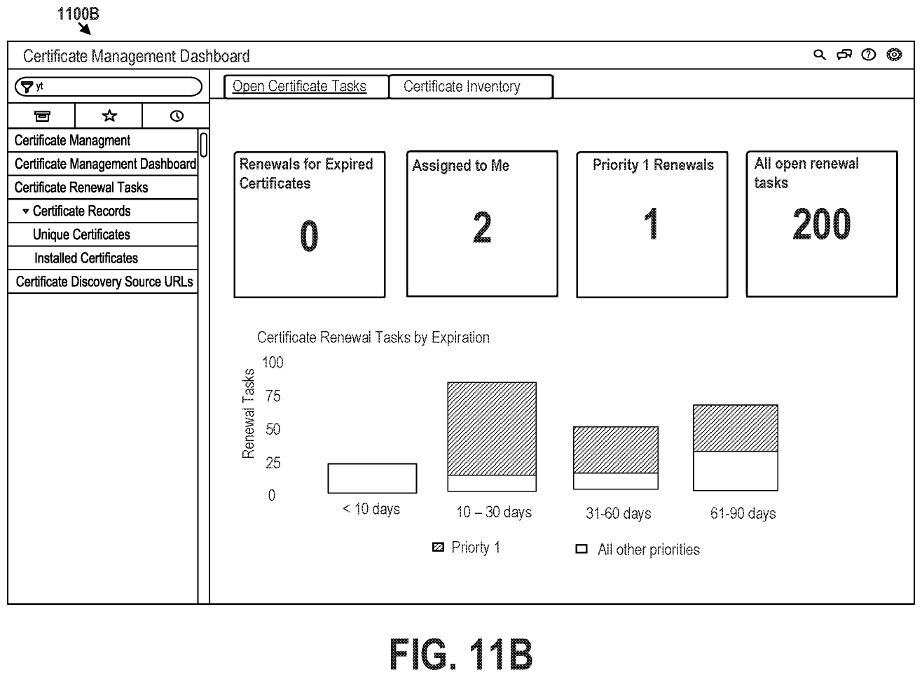

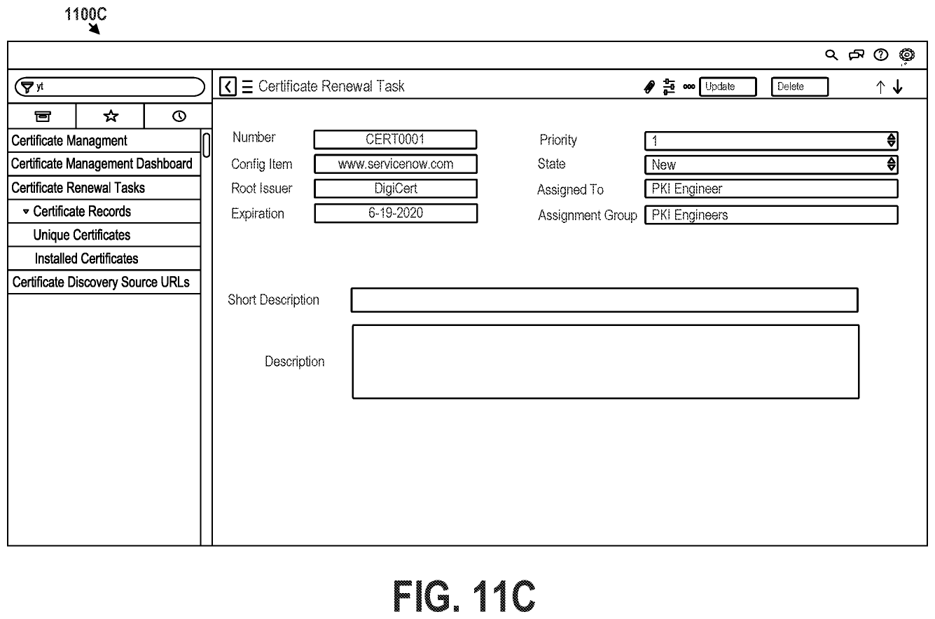

FIG. 11A illustrates web page 1100A, in accordance with example embodiments. Web page 1100A provides an overview of all digital certificates discovered on managed network 300. More specifically, web page 1100A provides specific metrics about all unique certificates, certificates with renewal tracking, critical digital certificates, and newly discovered certificates. Additionally, web page 1100A provides an intuitive graph that displays upcoming digital certificate expirations by month.

FIG. 11B illustrates web page 1100B, in accordance with example embodiments. Web page 1100B provides an overview of all certificate renewal tasks on managed network 300. As used herein, a certificate renewal task is the act of manually renewing a digital certificate from a certificate authority. While in some examples renewing the digital certificate is automated, sometimes the renewal of a digital certificate is performed manually by users from managed network 300. To assist with certificate renewal tasks, web page 1100B provides specific metrics about renewals for expired certificates, certificates renewal tasks assigned to a user accessing web page 1100B, high priority renewal tasks, and all open renewal tasks. Additionally, web page 1100B provides an intuitive graph that displays upcoming certificate renewal tasks by expiration date.

FIG. 11C illustrates web page 1100C, in accordance with example embodiments. Web page 1100C facilitates the management of certificate renewal tasks by allowing a user from managed network 300 to specify configuration and assignment details related to a particular digital certificate. For example, FIG. 11C shows that a certificate number, a priority, an issuer, an expiration date, and an certificate renewal task assignment can all be entered by way of web page 1100C.

Notably, web pages above are presented merely for purposes of illustration and are not intended to be limiting. Other web pages including alternative arrangements of information may also exist.

### VII. Example Operations

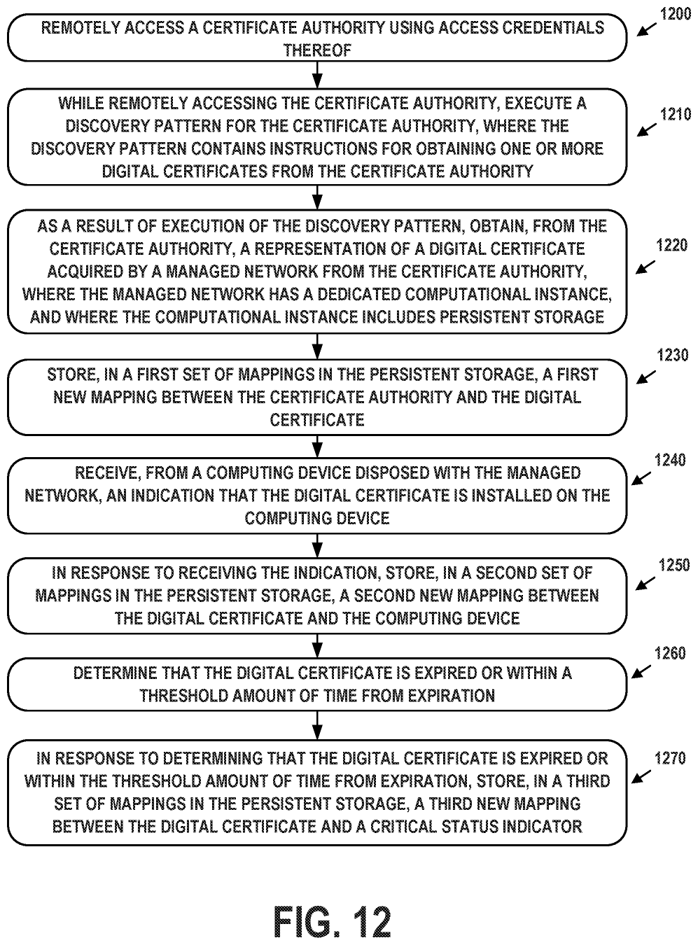

FIG. 12 is a flow chart illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

Block 1200 involves remotely accessing a certificate authority using access credentials thereof.

Block 1210 involves, while remotely accessing the certificate authority, executing a discovery pattern for the certificate authority, where the discovery pattern contains instructions for obtaining one or more digital certificates from the certificate authority.

Block 1220 involves, as a result of execution of the discovery pattern, obtaining, from the certificate authority, a representation of a digital certificate acquired by a managed network from the certificate authority, where the managed network has a dedicated computational instance, and where the computational instance includes persistent storage.

Block 1230 involves storing, in a first set of mappings in the persistent storage, a first new mapping between the certificate authority and the digital certificate.

Block 1240 involves receiving, from a computing device disposed with the managed network, an indication that the digital certificate is installed on the computing device.

Block 1250 involves, in response to receiving the indication, storing, in a second set of mappings in the persistent storage, a second new mapping between the digital certificate and the computing device.

Block 1260 involves determining that the digital certificate is expired or within a threshold amount of time from expiration.

Block 1270 involves, in response to determining that the digital certificate is expired or within the threshold amount of time from expiration, storing, in a third set of mappings in the persistent storage, a third new mapping between the digital certificate and a critical status indicator.

Some embodiments involve, as a further result of execution of the discovery pattern, obtaining, from the certificate authority, a representation of a second digital certificate acquired by the managed network from the certificate authority. The embodiments may also involve storing, in the first set of mappings, a fourth new mapping between the certificate authority and the second digital certificate. The embodiments may also involve receiving, from a second computing device disposed with the managed network, a second indication that the second digital certificate is installed on the second computing device and, in response to receiving the second indication, storing, in the second set of mappings, a fifth new mapping between the second digital certificate and the second computing device. The embodiments may also involve determining that the second digital certificate is not expired nor within the threshold amount of time from expiration and, in response to determining that the second digital certificate is not expired nor within the threshold amount of time from expiration, storing, in the third set of mappings, a sixth new mapping between the second digital certificate and a non-critical status indicator.

Some embodiments involve receiving, from a second computing device disposed with the managed network, a second indication that the digital certificate is installed on the second computing device and, in response to receiving the second indication, storing, in the second set of mappings, a fourth new mapping between the digital certificate and the second computing device.

Some embodiments involve remotely accessing a second certificate authority using second access credentials thereof and, while remotely accessing the second certificate authority, executing a second discovery pattern for the second certificate authority, where the second discovery pattern contains second instructions for obtaining one or more additional digital certificates from the second certificate authority. As a result of execution of the second discovery pattern, the embodiments may involve obtaining, from the second certificate authority, a representation of a second digital certificate acquired by the managed network from the second certificate authority and storing, in the first set of mappings, a fourth new mapping between the second certificate authority and the second digital certificate. The embodiments may also involve receiving, from a second computing device disposed with the managed network, a second indication that the second digital certificate is installed on the second computing device and, in response to receiving the second indication, storing, in the second set of mappings, a fifth new mapping between the second digital certificate and the second computing device. The embodiments may also involve determining that the second digital certificate is expired or within the threshold amount of time from expiration and, in response to determining that the second digital certificate is expired or within the threshold amount of time from expiration, storing, in the third set of mappings, a sixth new mapping between the second digital certificate and the critical status indicator.

Some embodiments involve determining, by way of scanning the third set of mappings, that the digital certificate is associated with the critical status indicator and, in response to determining that the digital certificate is associated with the critical status indicator, transmitting an alert to an administrative entity of the managed network, where the alert specifies that the digital certificate is associated with the critical status indicator.

In some embodiments, the alert is an email, a text message, or web page content.

Some embodiments involve determining, by way of scanning the third set of mappings, that the digital certificate is associated with the critical status indicator and, in response to determining that the digital certificate is associated with the critical status indicator, (i) remotely accessing the certificate authority using the access credentials thereof, and (ii) while remotely accessing the certificate authority, renewing the digital certificate. The embodiments may also involve installing, on the computing device, the digital certificate as renewed and updating the third new mapping so that the digital certificate is associated with a non-critical status indicator.

In some embodiments, the process illustrated by FIG. 11 is executable by one or more processors are disposed within a proxy server device, where the proxy server device is disposed within the managed network.

In some embodiments, receiving the indication that the digital certificate is installed on the computing device comprises: remotely probing the computing device as part of a discovery procedure and obtaining a copy of the digital certificate from the computing device.

In some embodiments, a system may involve means for remotely accessing a certificate authority using access credentials thereof. The system may additionally involve means for, while remotely accessing the certificate authority, executing a discovery pattern for the certificate authority, where the discovery pattern contains instructions for obtaining one or more digital certificates from the certificate authority. As a result of execution of the discovery pattern, the system may involve means for obtaining, from the certificate authority, a representation of a digital certificate acquired by a managed network from the certificate authority, where the managed network has a dedicated computational instance, and where the computational instance includes persistent storage. The system may additionally involve means for, storing, in a first set of mappings in the persistent storage, a first new mapping between the certificate authority and the digital certificate. The system may additionally involve means for receiving, from a computing device disposed with the managed network, an indication that the digital certificate is installed on the computing device and, in response to receiving the indication, storing, in a second set of mappings in the persistent storage, a second new mapping between the digital certificate and the computing device. The system may additionally involve means for determining that the digital certificate is expired or within a threshold amount of time from expiration and, in response to determining that the digital certificate is expired or within the threshold amount of time from expiration, storing, in a third set of mappings in the persistent storage, a third new mapping between the digital certificate and a critical status indicator.

### VIII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computing system comprising:
a computational instance including persistent storage, wherein the computational instance is dedicated to a managed network; and
one or more processors configured to:
remotely access a certificate authority using access credentials thereof;
while remotely accessing the certificate authority, execute a discovery pattern for the certificate authority, wherein the discovery pattern contains instructions for obtaining one or more digital certificates from the certificate authority;
as a result of execution of the discovery pattern, obtain, from the certificate authority, a representation of a digital certificate acquired by the managed network from the certificate authority;
store, in a first set of mappings in the persistent storage, a first new mapping between the certificate authority and the digital certificate;
receive, from a computing device disposed with the managed network, an indication that the digital certificate is installed on the computing device;
in response to receiving the indication, store, in a second set of mappings in the persistent storage, a second new mapping between the digital certificate and the computing device;
determine that the digital certificate is expired or within a threshold amount of time from expiration; and
in response to determining that the digital certificate is expired or within the threshold amount of time from expiration, store, in a third set of mappings in the persistent storage, a third new mapping between the digital certificate and a critical status indicator.

2. The computing system of claim 1, wherein the one or more processors are further configured to:
as a further result of execution of the discovery pattern, obtain, from the certificate authority, a representation of a second digital certificate acquired by the managed network from the certificate authority;
store, in the first set of mappings, a fourth new mapping between the certificate authority and the second digital certificate;
receive, from a second computing device disposed with the managed network, a second indication that the second digital certificate is installed on the second computing device;
in response to receiving the second indication, store, in the second set of mappings, a fifth new mapping between the second digital certificate and the second computing device;
determine that the second digital certificate is not expired nor within the threshold amount of time from expiration; and
in response to determining that the second digital certificate is not expired nor within the threshold amount of time from expiration, store, in the third set of mappings, a sixth new mapping between the second digital certificate and a non-critical status indicator.

3. The computing system of claim 1, wherein the one or more processors are further configured to:
receive, from a second computing device disposed with the managed network, a second indication that the digital certificate is installed on the second computing device; and
in response to receiving the second indication, store, in the second set of mappings, a fourth new mapping between the digital certificate and the second computing device.

4. The computing system of claim 1, wherein the one or more processors are further configured to:
remotely access a second certificate authority using second access credentials thereof;
while remotely accessing the second certificate authority, execute a second discovery pattern for the second certificate authority, wherein the second discovery pattern contains second instructions for obtaining one or more additional digital certificates from the second certificate authority;
as a result of execution of the second discovery pattern, obtain, from the second certificate authority, a representation of a second digital certificate acquired by the managed network from the second certificate authority;
store, in the first set of mappings, a fourth new mapping between the second certificate authority and the second digital certificate;
receive, from a second computing device disposed with the managed network, a second indication that the second digital certificate is installed on the second computing device;
in response to receiving the second indication, store, in the second set of mappings, a fifth new mapping between the second digital certificate and the second computing device;
determine that the second digital certificate is expired or within the threshold amount of time from expiration; and
in response to determining that the second digital certificate is expired or within the threshold amount of time from expiration, store, in the third set of mappings, a sixth new mapping between the second digital certificate and the critical status indicator.

5. The computing system of claim 1, wherein the one or more processors are further configured to:
determine, by way of scanning the third set of mappings, that the digital certificate is associated with the critical status indicator; and
in response to determining that the digital certificate is associated with the critical status indicator, transmit an alert to an administrative entity of the managed network, wherein the alert specifies that the digital certificate is associated with the critical status indicator.

6. The computing system of claim 5, wherein the alert is an email, a text message, or web page content.

7. The computing system of claim 1, wherein the one or more processors are further configured to:
determine, by way of scanning the third set of mappings, that the digital certificate is associated with the critical status indicator;
in response to determining that the digital certificate is associated with the critical status indicator, (i) remotely access the certificate authority using the access credentials thereof, and (ii) while remotely accessing the certificate authority, renew the digital certificate;
install, on the computing device, the digital certificate as renewed; and
update the third new mapping so that the digital certificate is associated with a non-critical status indicator.

8. The computing system of claim 1, wherein the one or more processors are disposed within a proxy server device, and wherein the proxy server device is disposed within the managed network.

9. The computing system of claim 1, wherein receiving the indication that the digital certificate is installed on the computing device comprises:
remotely probing the computing device as part of a discovery procedure; and
obtaining a copy of the digital certificate from the computing device.

10. A computer-implemented method executable by one or more processors, the method comprising:
remotely accessing a certificate authority using access credentials thereof;
while remotely accessing the certificate authority, executing a discovery pattern for the certificate authority, wherein the discovery pattern contains instructions for obtaining one or more digital certificates from the certificate authority;
as a result of execution of the discovery pattern, obtaining, from the certificate authority, a representation of a digital certificate acquired by a managed network from the certificate authority, wherein the managed network has a dedicated computational instance, and wherein the computational instance includes persistent storage;
storing, in a first set of mappings in the persistent storage, a first new mapping between the certificate authority and the digital certificate;
receiving, from a computing device disposed with the managed network, an indication that the digital certificate is installed on the computing device;
in response to receiving the indication, storing, in a second set of mappings in the persistent storage, a second new mapping between the digital certificate and the computing device;
determining that the digital certificate is expired or within a threshold amount of time from expiration; and
in response to determining that the digital certificate is expired or within the threshold amount of time from expiration, storing, in a third set of mappings in the persistent storage, a third new mapping between the digital certificate and a critical status indicator.

11. The computer-implemented method of claim 10, further comprising:
as a further result of execution of the discovery pattern, obtaining, from the certificate authority, a representation of a second digital certificate acquired by the managed network from the certificate authority;
storing, in the first set of mappings, a fourth new mapping between the certificate authority and the second digital certificate;
receiving, from a second computing device disposed with the managed network, a second indication that the second digital certificate is installed on the second computing device;
in response to receiving the second indication, storing, in the second set of mappings, a fifth new mapping between the second digital certificate and the second computing device;
determining that the second digital certificate is not expired nor within the threshold amount of time from expiration; and
in response to determining that the second digital certificate is not expired nor within the threshold amount of time from expiration, storing, in the third set of mappings, a sixth new mapping between the second digital certificate and a non-critical status indicator.

12. The computer-implemented method of claim 10, further comprising:
receiving, from a second computing device disposed with the managed network, a second indication that the digital certificate is installed on the second computing device; and
in response to receiving the second indication, storing, in the second set of mappings, a fourth new mapping between the digital certificate and the second computing device.

13. The computer-implemented method of claim 10, further comprising:
remotely accessing a second certificate authority using second access credentials thereof;
while remotely accessing the second certificate authority, executing a second discovery pattern for the second certificate authority, wherein the second discovery pattern contains second instructions for obtaining one or more additional digital certificates from the second certificate authority;
as a result of execution of the second discovery pattern, obtaining, from the second certificate authority, a representation of a second digital certificate acquired by the managed network from the second certificate authority;
storing, in the first set of mappings, a fourth new mapping between the second certificate authority and the second digital certificate;
receiving, from a second computing device disposed with the managed network, a second indication that the second digital certificate is installed on the second computing device;
in response to receiving the second indication, storing, in the second set of mappings, a fifth new mapping between the second digital certificate and the second computing device;
determining that the second digital certificate is expired or within the threshold amount of time from expiration; and
in response to determining that the second digital certificate is expired or within the threshold amount of time from expiration, storing, in the third set of mappings, a sixth new mapping between the second digital certificate and the critical status indicator.

14. The computer-implemented method of claim 10, further comprising:
determining, by way of scanning the third set of mappings, that the digital certificate is associated with the critical status indicator; and
in response to determining that the digital certificate is associated with the critical status indicator, transmitting an alert to an administrative entity of the managed network, wherein the alert specifies that the digital certificate is associated with the critical status indicator.

15. The computer-implemented method of claim 14, wherein the alert is an email, a text message, or web page content.

16. The computer-implemented method of claim 10, further comprising:
determining, by way of scanning the third set of mappings, that the digital certificate is associated with the critical status indicator;
in response to determining that the digital certificate is associated with the critical status indicator, (i) remotely accessing the certificate authority using the access credentials thereof, and (ii) while remotely accessing the certificate authority, renewing the digital certificate;
installing, on the computing device, the digital certificate as renewed; and
updating the third new mapping so that the digital certificate is associated with a non-critical status indicator.

17. The computer-implemented method of claim 10, wherein the one or more processors are disposed within a proxy server device, and wherein the proxy server device is disposed within the managed network.

18. The computer-implemented method of claim 10, wherein receiving the indication that the digital certificate is installed on the computing device comprises:
remotely probing the computing device as part of a discovery procedure; and
obtaining a copy of the digital certificate from the computing device.

19. An article of manufacture including a non-transitory computer-readable medium, having stored thereon program instructions that, upon execution by one or more processors, cause the one or more processors to perform operations comprising:
remotely accessing a certificate authority using access credentials thereof;
while remotely accessing the certificate authority, executing a discovery pattern for the certificate authority, wherein the discovery pattern contains instructions for obtaining one or more digital certificates from the certificate authority;
as a result of execution of the discovery pattern, obtaining, from the certificate authority, a representation of a digital certificate acquired by a managed network from the certificate authority, wherein the managed network has a dedicated computational instance, and wherein the computational instance includes persistent storage;
storing, in a first set of mappings in the persistent storage, a first new mapping between the certificate authority and the digital certificate;
receiving, from a computing device disposed with the managed network, an indication that the digital certificate is installed on the computing device;
in response to receiving the indication, storing, in a second set of mappings in the persistent storage, a second new mapping between the digital certificate and the computing device;
determining that the digital certificate is expired or within a threshold amount of time from expiration; and
in response to determining that the digital certificate is expired or within the threshold amount of time from expiration, storing, in a third set of mappings in the persistent storage, a third new mapping between the digital certificate and a critical status indicator.

20. The article of manufacture of claim 19, wherein the operations further comprise:
as a further result of execution of the discovery pattern, obtaining, from the certificate authority, a representation of a second digital certificate acquired by the managed network from the certificate authority;
storing, in the first set of mappings, a fourth new mapping between the certificate authority and the second digital certificate;
receiving, from a second computing device disposed with the managed network, a second indication that the second digital certificate is installed on the second computing device;
in response to receiving the second indication, storing, in the second set of mappings, a fifth new mapping between the second digital certificate and the second computing device;
determining that the second digital certificate is not expired nor within the threshold amount of time from expiration; and
in response to determining that the second digital certificate is not expired nor within the threshold amount of time from expiration, storing, in the third set of mappings, a sixth new mapping between the second digital certificate and a non-critical status indicator.
